(19) United States
(12) Patent Application Publication
(10) Pub. No.: US 2009/0163692 A1
(43) Pub. Date: Jun. 25, 2009

(54) AROMATIC POLYETHERS

(75) Inventors: David Roger Moore, Albany, NY (US); Gary William Yeager, Rexford, NY (US); Daniel Joseph Brunelle, Burnt Hills, NY (US); Marianne Elisabeth Harmon, Granada Hills, CA (US); Joyce Hung, Auburn, AL (US); Joseph Anthony Suriano, Clifton Park, NY (US); Hongyi Zhou, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/962,627

(22) Filed: Dec. 21, 2007

(51) Int. Cl. C08G 75/02

(52) U.S. Cl. 528/174; 528/391; 528/86

(57) ABSTRACT

An aromatic polyether comprising structural units derived from a halosulfone sulfonate having structure (I):

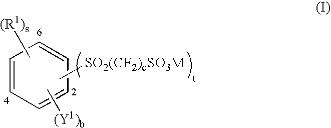

wherein R¹ is a C₃-C₂₅ aromatic radical, a C₃-C₂₅ cycloaliphatic radical, or a C₁-C₁₀ aliphatic radical; M is hydrogen or a charge balancing cation; Y¹ is independently at each occurrence a halogen; “t” is an integer having a value of 1 or 2; “s” is an integer having a value 0 to 3, “b” is an integer having a value 1 to 4; and “c” is an integer having a value 1 to 20. Also provided are methods of preparing the aromatic polyethers, and compositions including the aromatic polyethers.

### BACKGROUND

The invention includes embodiments that may relate to aromatic polyethers polymers prepared using halosulfone sulfonates, methods of preparing the aromatic polyethers, and compositions including the aromatic polyethers.

Electrocherical cells, such as fuel cells and lithium-ion batteries are known. Depending on the operating conditions, each type of cell places a particular set of requirements upon the electrolytes used in them. For fuel cells, this is typically dictated by the type of fuel, such as hydrogen or methanol, used to power the cell. Furthermore, the composition of the membrane used to separate the electrodes must be designed to meet rigorous performance requirements. Polymer electrolyte membrane fuel cells, also know as proton exchange membrane fuel cells, can be powered by hydrogen as the fuel, and can be run at higher operating temperatures than currently employed to take advantage of lower purity feed streams, improved electrode kinetics, and better heat transfer from the fuel cell stack to improve cooling. However, if current fuel cells are to be operated at greater than 100° C. then they must be pressurized to maintain adequate hydration of typical proton-exchange membranes, such as DuPont Nafion® perfluorosulfonic acid membrane, to support useful levels of proton conductivity.

Polymer electrolyte membrane (PEM) fuel cells have attracted significant attention as a reliable, clean source of energy, in particular for transportation and portable devices. As discussed above, a key to enabling fuel cell technology lies in high-performance membrane materials. Currently, fuel cell membranes are too expensive, exhibit poor chemical, mechanical, and thermal properties, and/or demonstrate insufficient conductivities under the necessary temperature and humidity requirements.

There exists a need for PEM materials exhibiting high proton conductivity at lower levels of hydration and demonstrating better water management that will be suitable for commercial applications. Furthermore, there exists a need for monomers that can provide aromatic polymers having more acidic functionality that will lead to highly conductive polymer electrolyte membranes providing long fuel cell lifetimes.

### BRIEF DESCRIPTION

In one embodiment, the present invention provides an aromatic polyether comprising structural units derived from a halosulfone sulfonate having structure (I):

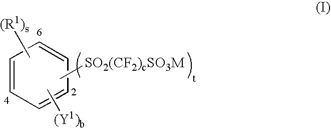

wherein R¹ is a C₃-C₂₅ aromatic radical, a C₃-C₂₅ cycloaliphatic radical, or a C₁-C₁₀ aliphatic radical; M is hydrogen or a charge balancing cation; Y¹ is independently at each occurrence a halogen; “t” is an integer having a value of 1 or 2; “s” is an integer having a value 0 to 3, “b” is an integer having a value 1 to 4; and “c” is an integer having a value 1 to 20.

In another embodiment, the present invention provides an aromatic polyether comprising structural units derived from halosulfone sulfonate having structure (II):

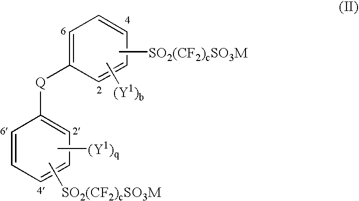

wherein Q is O, S, or SO₂; M is hydrogen or a charge balancing cation; Y¹ is independently at each occurrence a halogen; “b” is an integer having a value 1 to 4; “q” is an integer having a value 0 to 4; and “c” is an integer having a value 1 to 20.

In yet another embodiment, the present invention provides an aromatic polyether comprising structural units derived from a halosulfone sulfonate having structure (I) and an aromatic compound having structure (V):

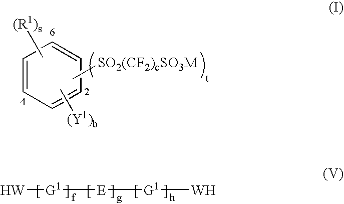

wherein R¹ is a C₃-C₂₅ aromatic radical, a C₃-C₂₅ cycloaliphatic radical, or a C₁-C₁₀ aliphatic radical; M is hydrogen or a charge balancing cation; Y¹ is independently at each occurrence a halogen; “t” is an integer having a value of 1 or 2; “s” is an integer having a value 0 to 3, “b” is an integer having a value 1 to 4; and “c” is an integer having a value 1 to 20; and wherein each G¹ is independently at each occurrence a C₃-C₂₅ aromatic radical; E is independently at each occurrence a bond, a C₃-C₂₅ cycloaliphatic radical, a C₃-C₂₅ aromatic radical, a C₁-C₂₀ aliphatic radical, a sulfur-containing linkage, a selenium-containing linkage, a phosphorus-containing linkage, or an oxygen atom; “f” is a number greater than or equal to 1; “g” is either 0 or 1; “h” is a whole number including 0; and W is independently at each occurrence O, S, or Se.

These and other features, aspects, and advantages of the present invention may be understood more readily by reference to the following detailed description.

### DETAILED DESCRIPTION

In the following specification and the claims, which follow, reference will be made to a number of terms, which shall be defined to have the following meanings.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical that comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical that comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis (cyclohex-4-yl) (i.e., —C₆H₁₀C(CF₃)₂ C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —O C₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms that is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms that is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilylpropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

In various embodiments, the present invention provides halosulfone sulfonates, intermediates for preparing the halosulfone sulfonates and methods for preparing these compounds. In still other embodiments, the present invention provides aromatic polyethers prepared using these halosulfone sulfonates, methods of preparing the aromatic polyethers, and compositions comprising the aromatic polyethers. The aromatic polyethers may be used as a polymer electrolyte membrane in electrochemical cells, and more particularly the aromatic polyethers may be used as a polymer electrolyte membrane in fuel cells.

In one embodiment, the present invention provides a halosulfone sulfonate having structure (I):

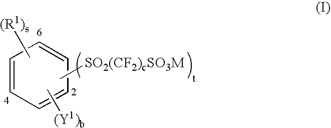

wherein R¹ is a C₃-C₂₅ aromatic radical, a C₃-C₂₅ cycloaliphatic radical, or a C₁-C₁₀ aliphatic radical; M is hydrogen or a charge balancing cation; Y¹ is independently at each occurrence a halogen; “t” is an integer having a value of 1 or 2; “s” is an integer having a value 0 to 3, “b” is an integer having a value 1 to 4; and “c” is an integer having a value 1 to 20.

In one embodiment, in structure (I) Y¹ may be fluorine, chlorine or a combination thereof, “s” is an integer having a value 0, and “b” is an integer having a value 2. In another embodiment, in structure (I) Y¹ may be attached to ring positions 2 and 4 of structure (I). In still another embodiment, in structure (I) Y¹ may be attached to ring positions 2 and 6 of structure (I).

In one embodiment, in structure (I) Y¹ is fluorine. In another embodiment, in structure (I) Y¹ is chlorine. In one embodiment, in structure (I) when “b” has a value 2, one Y¹ substituent may be chlorine and the other may be fluorine. In one embodiment, in structure (I) “c” is an integer having a value 2. In another embodiment, in structure (I) “c” is an integer having a value 3. In still another embodiment, in structure (I) “c” is an integer having a value 4. In one embodiment, in structure (I) “t” is an integer having a value 1.

In one embodiment, M in structure (I) may include an alkali metal cation or an alkaline earth metal cation. Non-limiting examples of alkali metal cations include sodium, potassium, and lithium. Non-limiting examples of alkaline earth metal cations include calcium, magnesium and barium.

In certain embodiments, R¹ in structure (I) is a C₃-C₂₅ aromatic radical which is free of aliphatic CH bonds. As used herein, the expression “free of aliphatic CH bonds” means that in certain embodiments R¹ may not contain any aliphatic carbon having a hydrogen substitution. Examples of R¹ aromatic radicals that are free of aliphatic CH bonds are illustrated in entries 13 and 14 in Table I. In certain embodiments, R¹ in structure (I) is a perfluoroaliphatic radical. Examples of R¹ as perfluoroaliphatic radicals are illustrated in entries 21, 22, 23, 24, 25, and 26 in Table I.

Non-limiting examples of suitable compounds represented by structure (I) are provided in Table I.

TABLE I
Examples of Haloalkane Sulfonates Having Structure (I)

| Entry | Structure | R¹ | Y¹ | S | b | C | M | t |
|---|---|---|---|---|---|---|---|---|
| 1 | 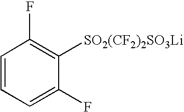 | — | F | 0 | 2 | 2 | Li | 1 |
| 2 | 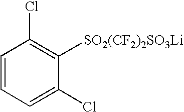 | — | Cl | 0 | 2 | 2 | Li | 1 |
| 3 | 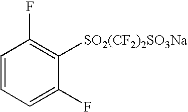 | — | F | 0 | 2 | 2 | Na | 1 |
| 4 | 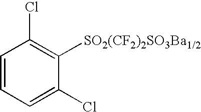 | — | Cl | 0 | 2 | 2 | Ba_{1/2} | 1 |
| 5 | 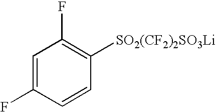 | — | F | 0 | 2 | 2 | Li | 1 |
| 6 | 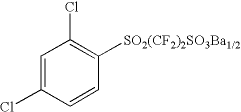 | — | Cl | 0 | 2 | 2 | Ba_{1/2} | 1 |
| 7 | 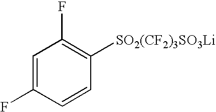 | — | F | 0 | 2 | 3 | Li | 1 |
| 8 | 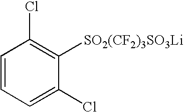 | — | Cl | 0 | 2 | 3 | Li | 1 |
| 9 | 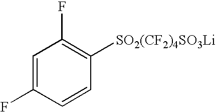 | — | F | 0 | 2 | 4 | Li | 1 |
| 10 | 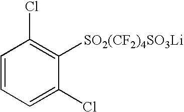 | — | Cl | 0 | 2 | 4 | Li | 1 |
| 11 | 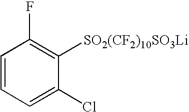 | — | F, Cl | 0 | 2 | 10 | Li | 1 |
| 12 | 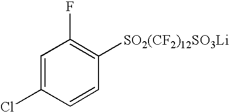 | — | F, Cl | 0 | 2 | 12 | Li | 1 |
| 13 | 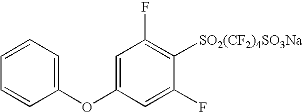 | 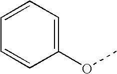 | F | 1 | 2 | 4 | Na | 1 |
| 14 | 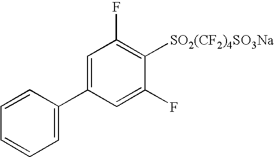 | 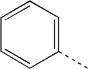 | F | 1 | 2 | 4 | Na | 1 |
| 15 | 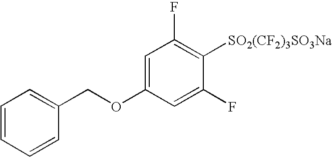 | 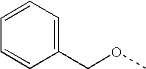 | F | 1 | 2 | 3 | Na | 1 |
| 16 | 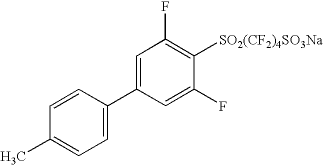 | 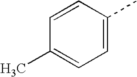 | F | 1 | 2 | 4 | Na | 1 |
| 17 | 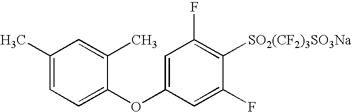 | 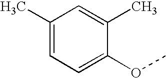 | F | 1 | 2 | 3 | Na | 1 |
| 18 | 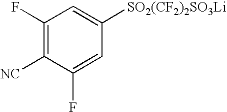 | —CN | F | 1 | 2 | 2 | Li | 1 |
| 19 | 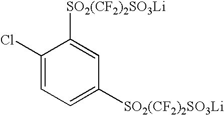 | — | Cl | 0 | 1 | 2 | Li | 2 |
| 20 | 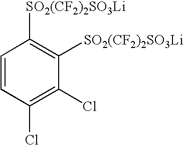 | — | Cl | 0 | 2 | 2 | Li | 2 |
| 21 | 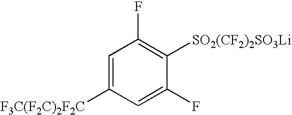 | —CF₂(CF₂)₂CF₃ | F | 1 | 2 | 2 | Li | 1 |
| 22 | 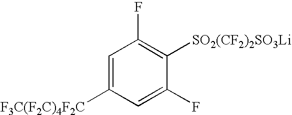 | —CF₂(CF₂)₄CF₃ | F | 1 | 2 | 2 | Li | 1 |
| 23 | 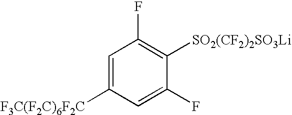 | —CF₂(CF₂)₆CF₃ | F | 1 | 2 | 2 | Li | 1 |
| 24 | 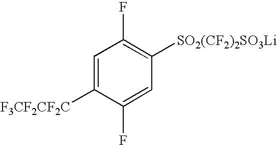 | —CF₂CF₂CF₃ | F | 1 | 2 | 2 | Li | 1 |
| 25 | 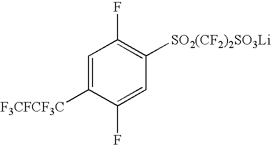 | —CF₃CFCF₃ | F | 1 | 2 | 2 | Li | 1 |
| 26 | 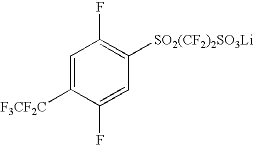 | —CF₂CF₃ | F | 1 | 2 | 2 | Li | 1 |
| 27 | 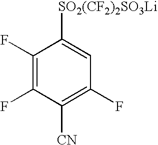 | —CN | F | 1 | 3 | 2 | Li | 1 |
| 28 | 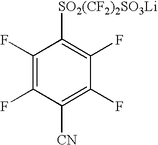 | —CN | F | 1 | 4 | 2 | Li | 1 |

In another embodiment, the present invention provides a halosulfone sulfonate having structure (II):

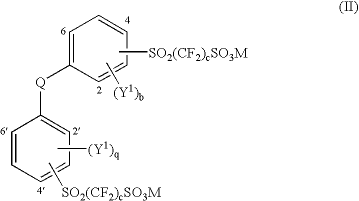

wherein Q is O, S, or SO₂; M is hydrogen or a charge balancing cation; Y¹ is independently at each occurrence a halogen; “b” is an integer having a value 1 to 4; “q” is an integer having a value 0 to 4; and “c” is an integer having a value 1 to 20.

In one embodiment, Y¹ in structure (II) is fluorine, chlorine or a combination thereof, and “b” is an integer having a value 2. In one embodiment, when “b” is an integer having a value 2, Y¹ is attached to ring positions 2 and 2′ of structure (II). In another embodiment, when “b” is an integer having a value 2, Y¹ is attached to ring positions 2,2′, 6 and 6′ of structure (II). In one embodiment, when “b” is an integer having a value 1, Y¹ is attached to ring positions 4 and 4′ of structure (II).

In one embodiment, in structure (II) Y¹ is fluorine. In another embodiment, in structure (II) Y¹ is chlorine. In one embodiment, in structure (II) when “b” is an integer having a value 2, one Y¹ substituent is chlorine and the other is fluorine.

In one embodiment, in structure (II) “c” is an integer having a value 2. In another embodiment, in structure (II) “c” is an integer having a value 3. In still another embodiment, in structure (II) “c” is an integer having a value 4. In one embodiment, M in structure (II) may include an alkali metal cation or an alkaline earth metal cation.

One skilled in the art will appreciate that structure (II) represents a sub-genus of structure (I), wherein “s” is an integer having a value 1 and R¹ is represented by

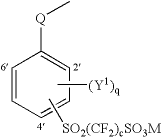

wherein Q is O, S, or SO₂; M is hydrogen or a charge balancing cation; Y¹ is independently at each occurrence a halogen; “q” is an integer having a value 0 to 4; and “c” is an integer having a value 1 to 20.

Non-limiting examples of suitable compounds represented by structure (II) are provided in Table II.

TABLE II
Examples of Haloalkane Sulfonates Having Structure (II)

| Entry | Structure | R¹ | Y¹ | b | q | c | M | Q |
|---|---|---|---|---|---|---|---|---|
| 1 | 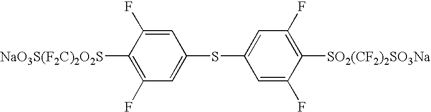 | 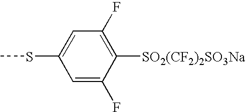 | F | 2 | 2 | 2 | Na | S |
| 2 | 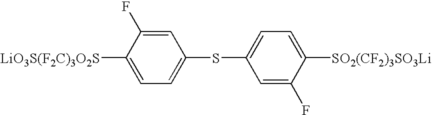 | 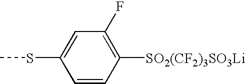 | F | 1 | 1 | 3 | Li | S |
| 3 | 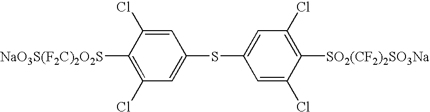 | 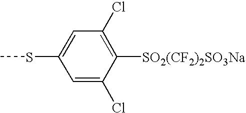 | Cl | 2 | 2 | 2 | Na | S |
| 4 | 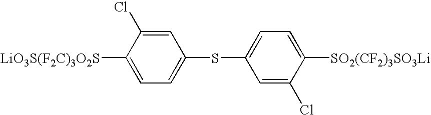 | 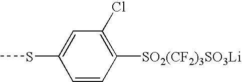 | Cl | 1 | 1 | 3 | Li | S |
| 5 | 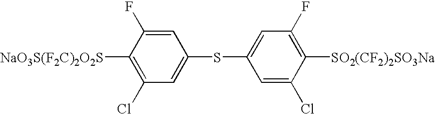 | 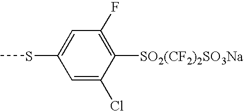 | F, Cl | 2 | 2 | 2 | Na | S |
| 6 | 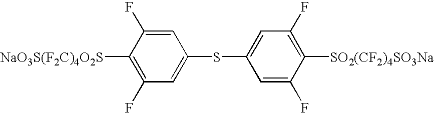 | 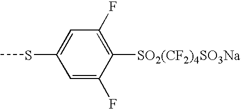 | F | 2 | 2 | 4 | Na | S |
| 7 | 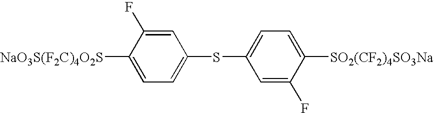 | 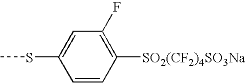 | F | 1 | 1 | 4 | Na | S |
| 8 | 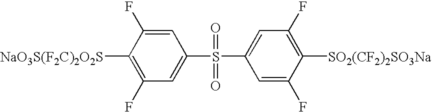 | 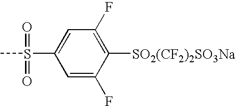 | F | 2 | 2 | 2 | Na | SO₂ |
| 9 | 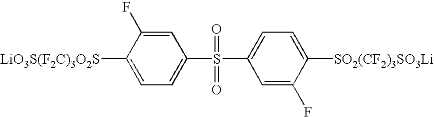 | 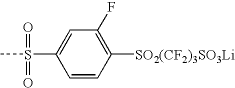 | F | 1 | 1 | 3 | Li | SO₂ |
| 10 | 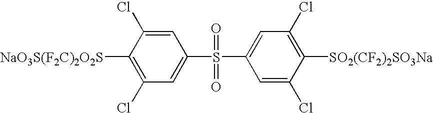 | 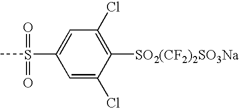 | Cl | 2 | 2 | 2 | Na | SO₂ |
| 11 | 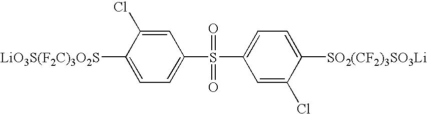 | 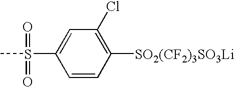 | Cl | 1 | 1 | 3 | Li | SO₂ |
| 12 | 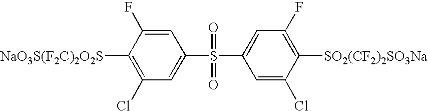 | 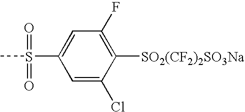 | F, Cl | 2 | 2 | 2 | Na | SO₂ |
| 13 | 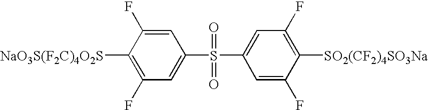 | 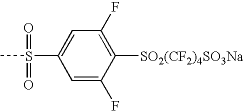 | F | 2 | 2 | 4 | Na | SO₂ |
| 14 | 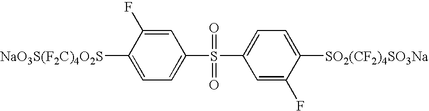 | 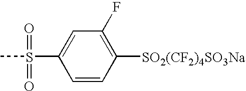 | F | 1 | 1 | 4 | Na | SO₂ |
| 15 | 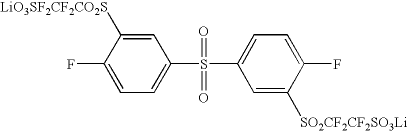 | 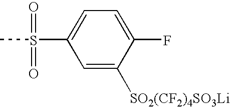 | F | 1 | 1 | 2 | Li | SO₂ |
| 16 | 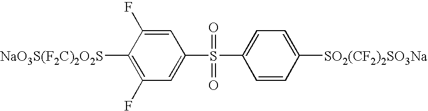 | 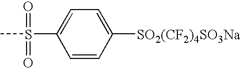 | F | 2 | 0 | 2 | Na | SO₂ |

The halosulfone sulfonate compounds of the present invention may be prepared by a variety of methods including those provided in the example section of this disclosure. In one embodiment, a halosulfone sulfonate may be prepared by subjecting a halothiobenzene compound to a series of reaction steps as described below.

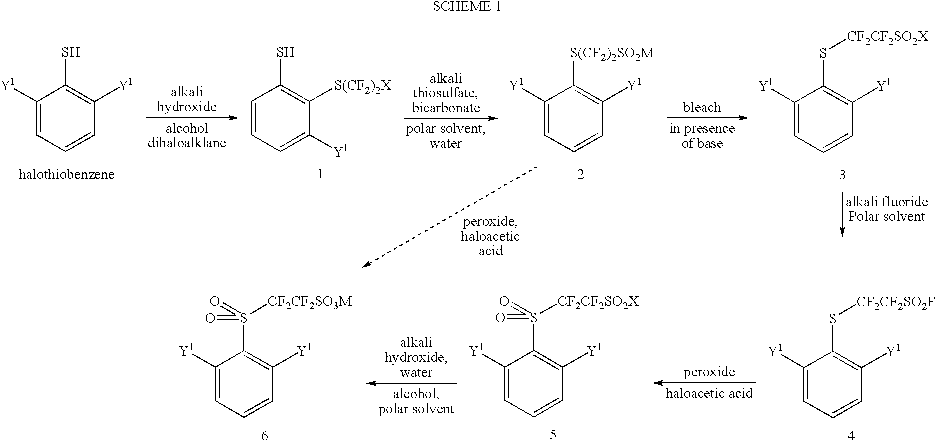

As shown in Scheme 1 a halothiobenzene can be converted to the corresponding aromatic sulfinate (2) via the formation of a haloalkane substituted halothiobenzene (1) by employing reaction conditions similar to those described in Feiring, A. E.; Wonchoba, E. R. J. Fluor. Chem. 2000, 105, 129-135. The aromatic sulfinate (2) can then be reacted with bleach in the presence of a base to form the corresponding aromatic sulfonyl chloride (3). The sulfonyl chloride (3) may then be transformed into the sulfonyl fluoride (4) by reacting with an alkali fluoride in a polar solvent. The sulfonyl fluoride (4) may be oxidized to the corresponding aromatic sulfone (5) using peroxide with haloacetic acid as the oxidizing agent under reflux. Performing the oxidization under reflux conditions may assist in minimizing the formation of sulfoxide impurities. The aromatic sulfone (5) may then be hydrolyzed with alkali metal hydroxide in an aqueous solution containing alcohol and a polar solvent to provided the haloalkane sulfonate (6) of the present invention. Alternately direct oxidation of aromatic sulfinate (2) with peroxide and haloacetic acid may also lead to the formation of the haloalkane sulfonate (6). In various embodiments, the variables Y¹, X and M shown in scheme 1, have similar meanings as described above. For example, lithium 2-(2,6-dichlorophenylsulfonyl)tetrafluoroethanesulfonate, entry 2 in Table I may be prepared by following the synthetic route provided in Scheme 2 in the experimental section.

In yet another embodiment, the present invention provides an aromatic sulfinate having structure (III):

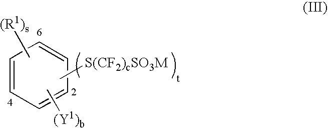

wherein R¹ is a C₃-C₂₅ aromatic radical, a C₃-C₂₅ cycloaliphatic radical, or a C₁-C₁₀ aliphatic radical; M is hydrogen or a charge balancing cation; Y¹ is independently at each occurrence a halogen; “t” is an integer having a value of 1 or 2; “s” is an integer having a value 0 to 3; “b” is an integer having a value 1 to 4; and “c” is an integer having a value 1 to 20.

In one embodiment, in structure (III) Y¹ may be fluorine, chlorine or a combination thereof, “s” is an integer having a value O, and “b” is an integer having a value 2. In another embodiment, in structure (III) Y¹ may be attached to ring positions 2 and 4 of structure (III). In still another embodiment, in structure (III) Y¹ may be attached to ring positions 2 and 6 of structure (III).

In one embodiment, in structure (III) Y¹ is fluorine. In another embodiment, in structure (III) Y¹ is chlorine. In one embodiment, in structure (III) when “b” has a value 2, one Y¹ substituent may be chlorine and the other may be fluorine. In one embodiment, in structure (III) “c” is an integer having a value 2. In another embodiment, in structure (III) “c” is an integer having a value 3. In still another embodiment, in structure (III) “c” is an integer having a value 4. In one embodiment, in structure (III) “t” is an integer having a value 1. In one embodiment, M in structure (III) may include an alkali metal cation or an alkaline earth metal cation.

In certain embodiments, R¹ in structure (III) is a C₃-C₂₅ aromatic radical which is free of aliphatic CH bonds. Examples of R¹ aromatic radicals that are free of aliphatic CH bonds are illustrated in entries 15 and 16 in Table III. In certain embodiments, R¹ in structure (II) is a perfluoroaliphatic radical. Examples of R¹ as perfluoroaliphatic radicals are illustrated in entries 23, 24, 25, 26, 27, and 28 in Table III. In one embodiment, the aromatic sulfinate (2) may be prepared in a similar manner as discussed in Scheme 1 above.

Non-limiting examples of suitable compounds represented by structure (III) are provided in Table III.

TABLE III
Examples of Aromatic Sulfinates Having Structure (III)

| Entry | Structure | R¹ | Y¹ | s | b | c | M | T |
|---|---|---|---|---|---|---|---|---|
| 1 | 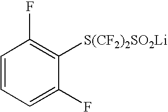 | — | F | 0 | 2 | 2 | Li | 1 |
| 2 | 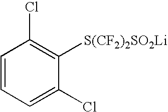 | — | Cl | 0 | 2 | 2 | Li | 1 |
| 3 | 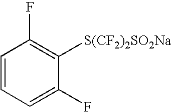 | — | F | 0 | 2 | 2 | Na | 1 |
| 4 | 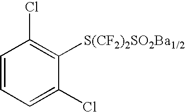 | — | Cl | 0 | 2 | 2 | Ba_{1/2} | 1 |
| 5 | 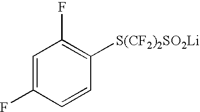 | — | F | 0 | 2 | 2 | Li | 1 |
| 6 | 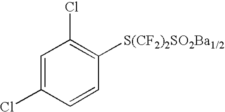 | — | Cl | 0 | 2 | 2 | Ba_{1/2} | 1 |
| 7 | 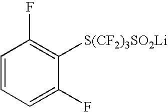 | — | F | 0 | 2 | 3 | Li | 1 |
| 8 | 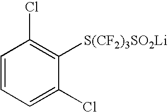 | — | Cl | 0 | 2 | 3 | Li | 1 |
| 9 | 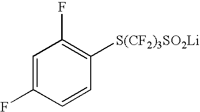 | — | F | 0 | 2 | 3 | Li | 1 |
| 10 | 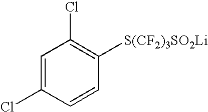 | — | Cl | 0 | 2 | 3 | Li | 1 |
| 11 | 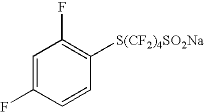 | — | F | 0 | 2 | 4 | Na | 1 |
| 12 | 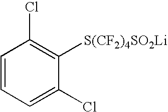 | — | Cl | 0 | 2 | 4 | Li | 1 |
| 13 | 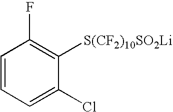 | — | F, Cl | 0 | 2 | 10 | Li | 1 |
| 14 | 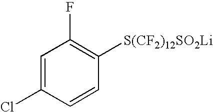 | — | F, Cl | 0 | 2 | 12 | Li | 1 |
| 15 | 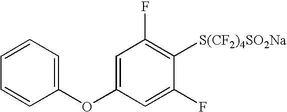 | 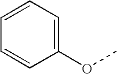 | F | 1 | 2 | 4 | Na | 1 |
| 16 | 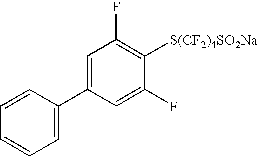 | 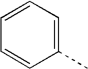 | F | 1 | 2 | 4 | Na | 1 |
| 17 | 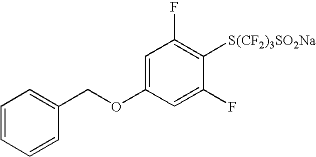 | 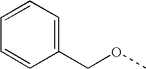 | F | 1 | 2 | 3 | Na | 1 |
| 18 | 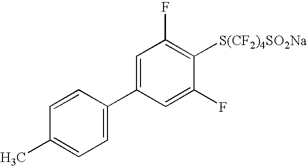 | 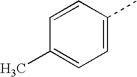 | F | 1 | 2 | 4 | Na | 1 |
| 19 | 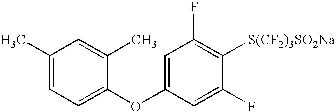 | 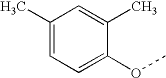 | F | 1 | 2 | 3 | Na | 1 |
| 20 | 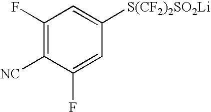 | —CN | F | 1 | 2 | 2 | Li | 1 |
| 21 | 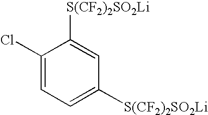 | — | Cl | 0 | 1 | 2 | Li | 2 |
| 22 | 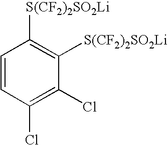 | — | Cl | 0 | 2 | 2 | Li | 2 |
| 23 | 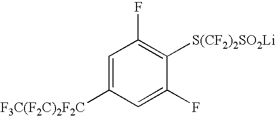 | —CF₂(CF₂)₂CF₃ | F | 1 | 2 | 2 | Li | 1 |
| 24 | 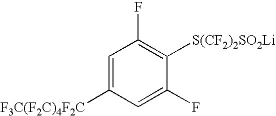 | —CF₂(CF₂)₄CF₃ | F | 1 | 2 | 2 | Li | 1 |
| 25 | 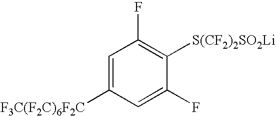 | —CF₂(CF₂)₆CF₃ | F | 1 | 2 | 2 | Li | 1 |
| 26 | 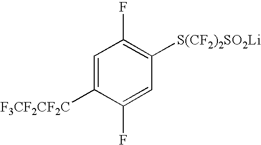 | —CF₂CF₂CF₃ | F | 1 | 2 | 2 | Li | 1 |
| 27 | 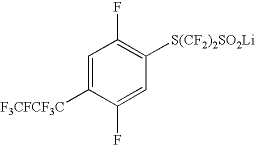 | —CF₃CFCF₃ | F | 1 | 2 | 2 | Li | 1 |
| 28 | 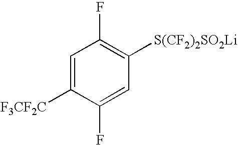 | —CF₂CF₃ | F | 1 | 2 | 2 | Li | 1 |
| 29 | 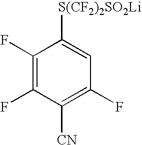 | —CN | F | 1 | 3 | 2 | Li | 1 |
| 30 | 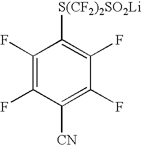 | —CN | F | 1 | 4 | 2 | Li | 1 |

In yet still another embodiment, the present invention provides a sulfonyl halide having structure (IV):

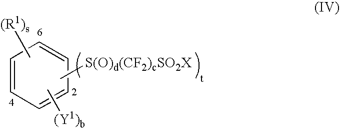

wherein R¹ is a C₃-C₂₅ aromatic radical, a C₃-C₂₅ cycloaliphatic radical, or a C₁-C₁₀ aliphatic radical; X is independently at each occurrence a halogen; Y¹ is independently at each occurrence a halogen; “t” is an integer having a value of 1 or 2; “s” is an integer having a value 0 to 3; “b” is an integer having a value 1 to 4; “c” is an integer having a value 1 to 20; and “d” is an integer having a value 0 to 2.

In one embodiment, in structure (IV) Y¹ may be fluorine, chlorine or a combination thereof, “s” is an integer having a value O, and “b” is an integer having a value 2. In another embodiment, in structure (IV) Y¹ may be attached to ring positions 2 and 4 of structure (IV). In still another embodiment, in structure (IV) Y¹ may be attached to ring positions 2 and 6 of structure (IV).

In one embodiment, in structure (IV) Y¹ is fluorine. In another embodiment, in structure (IV) Y¹ is chlorine. In one embodiment, in structure (IV) when “b” has a value 2, one Y¹ substituent may be chlorine and the other may be fluorine. In one embodiment, in structure (IV) X is fluorine. In another embodiment, in structure (IV) X is chlorine. In yet another embodiment, in structure (IV) X is bromine.

In one embodiment, in structure (IV) “c” is an integer having a value 2. In another embodiment, in structure (IV) “c” is an integer having a value 3. In still another embodiment, in structure (IV) “c” is an integer having a value 4. In one embodiment, in structure (IV) “t” is an integer having a value 1. In one embodiment, in structure (IV) “d” is an integer having a value 0. In another embodiment, in structure (IV) “d” is an integer having a value 2. In one embodiment, M in structure (IV) may include an alkali metal cation or an alkaline earth metal cation.

In certain embodiments, R¹ in structure (IV) is a C₃-C₂₅ aromatic radical which is free of aliphatic CH bonds. Examples of R¹ aromatic radicals that are free of aliphatic CH bonds are illustrated in entries 13, 14, 34, and 35 in Table IV. In certain embodiments, R¹ in structure (IV) is a perfluoroaliphatic radical. Examples of R¹ as perfluoroaliphatic radicals are illustrated in entries 49, 50, 51, 52, 53, 54, 55, 56, 57, 58, 59, and 60 in Table IV.

In one embodiment, the sulfonyl halide having structure (IV), for example, represented by sulfonyl fluoride (4) and aromatic sulfone (5) may be prepared in a similar manner as discussed in Scheme 1 above.

Non-limiting examples of suitable compounds represented by structure (IV) are listed in Table IV.

TABLE IV
Examples of Sulfonyl Fluorides and Aromatic Sulfones Having Structure (IV)

| Entry | Structure | R¹ | Y¹ | s | b | c | d | X | t |
|---|---|---|---|---|---|---|---|---|---|
| 1 | 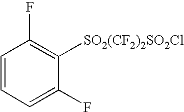 | — | F | 0 | 2 | 2 | 2 | Cl | 1 |
| 2 | 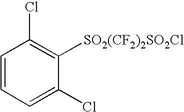 | — | Cl | 0 | 2 | 2 | 2 | Cl | 1 |
| 3 | 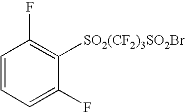 | — | F | 0 | 2 | 3 | 2 | Br | 1 |
| 4 | 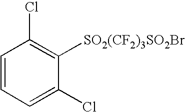 | — | Cl | 0 | 2 | 3 | 2 | Br | 1 |
| 5 | 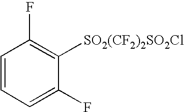 | — | F | 0 | 2 | 2 | 2 | Cl | 1 |
| 6 | 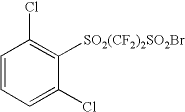 | — | Cl | 0 | 2 | 2 | 2 | Br | 1 |
| 7 | 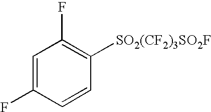 | — | F | 0 | 2 | 3 | 2 | F | 1 |
| 8 | 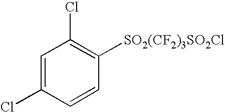 | — | Cl | 0 | 2 | 3 | 2 | Cl | 1 |
| 9 | 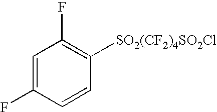 | — | F | 0 | 2 | 4 | 2 | Cl | 1 |
| 10 | 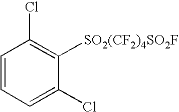 | — | Cl | 0 | 2 | 4 | 2 | F | 1 |
| 11 | 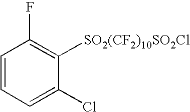 | — | F, Cl | 0 | 2 | 10 | 2 | Cl | 1 |
| 12 | 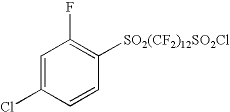 | — | F, Cl | 0 | 2 | 12 | 2 | Cl | 1 |
| 13 | 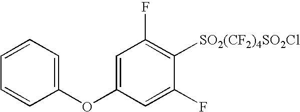 | 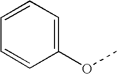 | F | 1 | 2 | 4 | 2 | Cl | 1 |
| 14 | 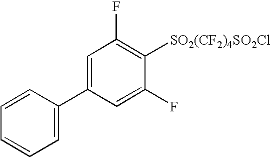 | 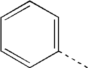 | F | 1 | 2 | 4 | 2 | Cl | 1 |
| 15 | 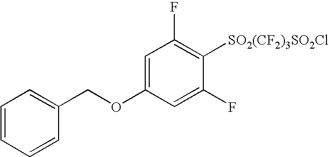 | 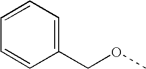 | F | 1 | 2 | 3 | 2 | Cl | 1 |
| 16 | 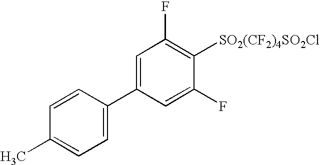 | 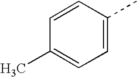 | F | 1 | 2 | 4 | 2 | Cl | 1 |
| 17 | 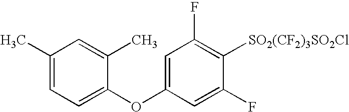 | 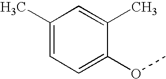 | F | 1 | 2 | 3 | 2 | Cl | 1 |
| 18 | 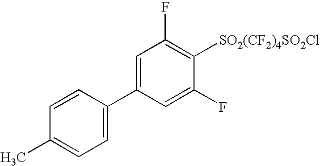 | 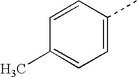 | F | 1 | 2 | 4 | 2 | Cl | 1 |
| 19 | 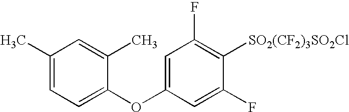 | 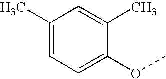 | F | 1 | 2 | 3 | 2 | Cl | 1 |
| 20 | 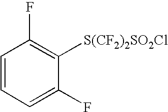 | — | F | 0 | 2 | 2 | 0 | Cl | 1 |
| 21 | 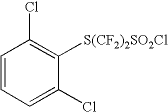 | — | Cl | 0 | 2 | 2 | 0 | Cl | 1 |
| 22 | 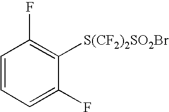 | — | F | 0 | 2 | 2 | 0 | Br | 1 |
| 23 | 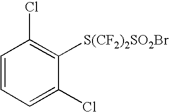 | — | Cl | 0 | 2 | 2 | 0 | Br | 1 |
| 24 | 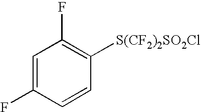 | — | F | 0 | 2 | 2 | 0 | Cl | 1 |
| 25 | 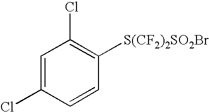 | — | Cl | 0 | 2 | 2 | 0 | Br | 1 |
| 26 | 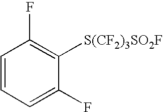 | — | F | 0 | 2 | 3 | 0 | F | 1 |
| 27 | 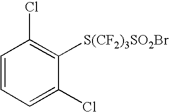 | — | Cl | 0 | 2 | 3 | 0 | Br | 1 |
| 28 | 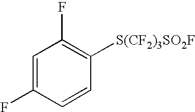 | — | F | 0 | 2 | 3 | 0 | F | 1 |
| 29 | 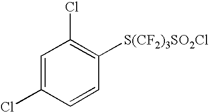 | — | Cl | 0 | 2 | 3 | 0 | Cl | 1 |
| 30 | 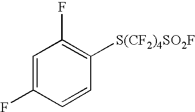 | — | F | 0 | 2 | 4 | 0 | F | 1 |
| 31 | 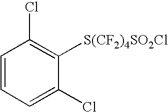 | — | Cl | 0 | 2 | 4 | 0 | Cl | 1 |
| 32 | 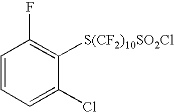 | — | F, Cl | 0 | 2 | 10 | 0 | Cl | 1 |
| 33 | 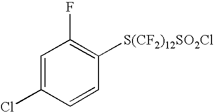 | — | F, Cl | 0 | 2 | 12 | 0 | Cl | 1 |
| 34 | 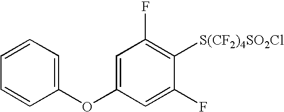 | 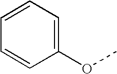 | F | 1 | 2 | 4 | 0 | Cl | |
| 35 | 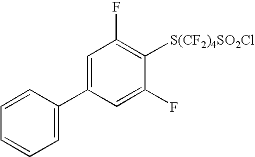 | 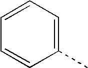 | F | 1 | 2 | 4 | 0 | Cl | 1 |
| 36 | 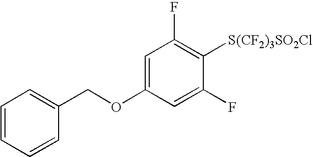 | 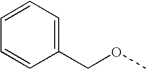 | F | 1 | 2 | 3 | 0 | Cl | 1 |
| 37 | 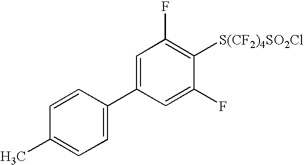 | 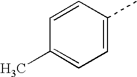 | F | 1 | 2 | 4 | 0 | Cl | 1 |
| 38 | 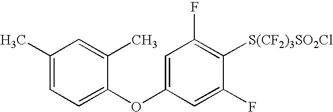 | 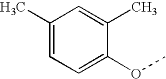 | F | 1 | 2 | 3 | 0 | Cl | 1 |
| 39 | 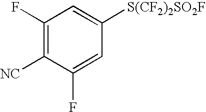 | —CN | F | 1 | 2 | 2 | 0 | F | 1 |
| 40 | 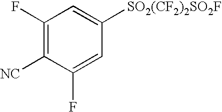 | —CN | F | 1 | 2 | 2 | 2 | F | 1 |
| 41 | 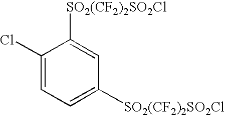 | — | Cl | 0 | 1 | 2 | 2 | Cl | 2 |
| 42 | 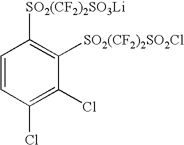 | — | Cl | 0 | 2 | 2 | 2 | Cl | 2 |
| 43 | 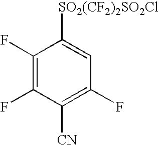 | —CN | F | 1 | 3 | 2 | 2 | Cl | 1 |
| 44 | 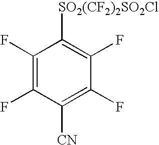 | —CN | F | 1 | 4 | 2 | 2 | Cl | 1 |
| 45 | 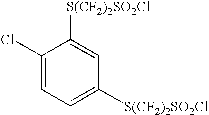 | — | Cl | 0 | 1 | 2 | 0 | Cl | 2 |
| 46 | 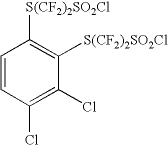 | — | Cl | 0 | 2 | 2 | 0 | Cl | 2 |
| 47 | 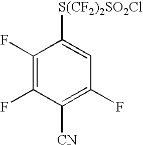 | —CN | F | 1 | 3 | 2 | 0 | Cl | 1 |
| 48 | 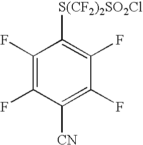 | —CN | F | 1 | 4 | 2 | 0 | Cl | 1 |
| 49 | 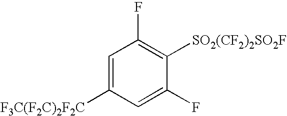 | —CF₂(CF₂)₂CF₃ | F | 1 | 2 | 2 | 2 | F | 1 |
| 50 | 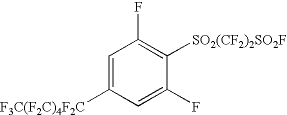 | —CF₂(CF₂)₄CF₃ | F | 1 | 2 | 2 | 2 | F | 1 |
| 51 | 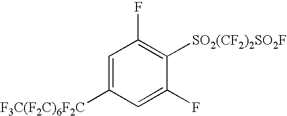 | —CF₂(CF₂)₆CF₃ | F | 1 | 2 | 2 | 2 | F | 1 |
| 52 | 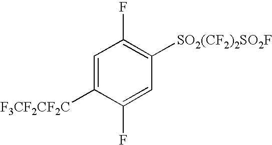 | —CF₂CF₂CF₃ | F | 1 | 2 | 2 | 2 | F | 1 |
| 53 | 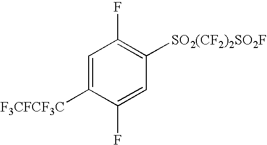 | —CF₃CFCF₃ | F | 1 | 2 | 2 | 2 | F | 1 |
| 54 | 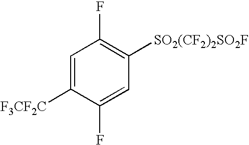 | —CF₂CF₃ | F | 1 | 2 | 2 | 2 | F | 1 |
| 55 | 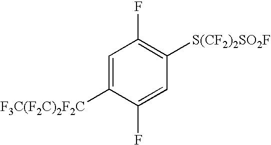 | —CF₂(CF₂)₂CF₃ | F | 1 | 2 | 2 | 0 | F | 1 |
| 56 | 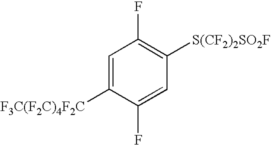 | —CF₂(CF₂)₄CF₃ | F | 1 | 2 | 2 | 0 | F | 1 |
| 57 | 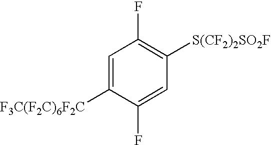 | —CF₂(CF₂)₆CF₃ | F | 1 | 2 | 2 | 0 | F | 1 |
| 58 | 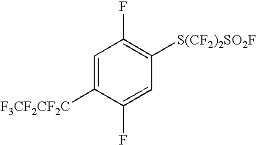 | —CF₂CF₂CF₃ | F | 1 | 2 | 2 | 0 | F | 1 |
| 59 | 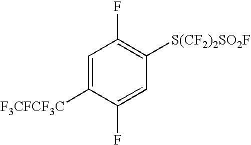 | —CF₃CFCF₃ | F | 1 | 2 | 2 | 0 | F | 1 |
| 60 | 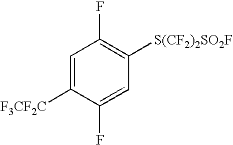 | —CF₂CF₃ | F | 1 | 2 | 2 | 0 | F | 1 |

In one embodiment, the present invention provides an aromatic polyether comprising structural units derived from a halosulfone sulfonate having structure (I). In one embodiment, the aromatic polyether comprising structural units derived from a halosulfone sulfonate having structure (I) has a number average molecular weight in a range between about 500 and about 1,00,000 grams per mole. In another embodiment, the aromatic polyether has a number average molecular weight in a range between about 1,000 and about 90,000 grams per mole. In yet another embodiment, the aromatic polyether has a number average molecular weight in a range between about 5,000 and about 50,000 grams per mole.

In another embodiment, the aromatic polyether comprising structural units derived from a halosulfone sulfonate having structure (I) has a weight average molecular weight in a range between about 5,000 and about 1,50,000 grams per mole. In yet another embodiment, the aromatic polyether has a weight average molecular weight in a range between about 6,000 and about 1,00,000 grams per mole. In still yet another embodiment, the aromatic polyether has a weight average molecular weight in a range between about 7,000 and about 70,000 grams per mole.

In one embodiment, the aromatic polyether comprising structural units derived from a haloaromatic sulfonate having structure (I) has a proton conductivity in a range between about 0.001 Siemens per centimeter (S/cm) and about 0.5 S/cm at 80° C. and 100 percent relative humidity. In yet another embodiment, the aromatic polyether has a proton conductivity in a range between about 0.01 S/cm and about 0.3 S/cm at 80° C. and 100 percent relative humidity. In still yet another embodiment, the aromatic polyether has a proton conductivity in a range between about 0.03 S/cm and about 0.1 S/cm at 80° C. and 100 percent relative humidity.

In another embodiment, the present invention provides an aromatic polyether comprising structural units derived from halosulfone sulfonate having structure (II). In one embodiment, the aromatic polyether comprising structural units derived from a halosulfone sulfonate having structure (II) has a number average molecular weight in a range between about 500 and about 1,00,000 grams per mole. In another embodiment, the aromatic polyether has a number average molecular weight in a range between about 1,000 and about 90,000 grams per mole. In yet another embodiment, the aromatic polyether has a number average molecular weight in a range between about 5,000 and about 50,000 grams per mole.

In another embodiment, the aromatic polyether comprising structural units derived from a halosulfone sulfonate having structure (II) has a weight average molecular weight in a range between about 5,000 and about 1,50,000 grams per mole. In yet another embodiment, the aromatic polyether has a weight average molecular weight in a range between about 6,000 and about 1,00,000 grams per mole. In still yet another embodiment, the aromatic polyether has a weight average molecular weight in a range between about 7,000 and about 70,000 grams per mole.

In one embodiment, the present invention provides an aromatic polyether comprising structural units derived from halosulfone sulfonate (I), halosulfone sulfonate (II), or a combination thereof, and further comprises structural units derived from an aromatic compound having structure (V):

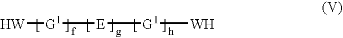

wherein each G¹ is independently at each occurrence a C₃-C₂₅ aromatic radical; E is independently at each occurrence a bond, a C₃-C₂₅ cycloaliphatic radical, a C₃-C₂₅ aromatic radical, a C₁-C₂₀ aliphatic radical, a sulfur-containing linkage, a selenium-containing linkage, a phosphorus-containing linkage, or an oxygen atom; “f” is a number greater than or equal to 1; “g” is either 0 or 1; “h” is a whole number including 0; and W is independently at each occurrence O, S, or Se.

Non-limiting examples of suitable aromatic compounds include 1,1-bis(4-hydroxyphenyl)cyclopentane; 2,2-bis(3-allyl-4-hydroxyphenyl)propane; 2,2-bis(2-t-butyl-4-hydroxy-5-methylphenyl)propane; 2,2-bis(3-t-butyl-4-hydroxy-6-methylphenyl)propane; 2,2-bis(3-t-butyl-4-hydroxy-6-methylphenyl)butane; 4,4′-biphenol; 2,2′,6,8-tetramethyl-3,3′,5,5′-tetrabromo-4,4′-biphenol; 2,2′,6,6′-tetramethyl-3,3′,5-tribromo-4,4′-biphenol; 1,1-bis(4-hydroxyphenyl)-2,2,2-trichloroethane; 1,1-bis(4-hydroxyphenyl)ethane; 1,1-bis(4-hydroxy-2-chlorophenyl)ethane; 2,2-bis(4-hydroxyphenyl)propane (bisphenol-A); 1,1-bis(4-hydroxyphenyl)propane; 2,2-bis(3-chloro-4-hydroxyphenyl)propane; 1,1-bis(3-phenyl-4-hydroxyphenyl)cyclohexane; 1,1-bis(3,5-dichloro-4-hydroxyphenyl)cyclohexane; 1,1-bis(3,5-dibromo-4-hydroxyphenyl)cyclohexane; 1,1-bis(3,5-dimethyl-4-hydroxyphenyl)cyclohexane; 4,4′-[1-methyl-4-(1-methyl-ethyl)-1,3-cyclohexandiyl]bisphenol (1,3 BHPM); 4-[1-[3-(4-hydroxyphenyl)-4-methylcyclohexyl]-1-methyl-ethyl]-phenol (2,8 BHPM); 3,8-dihydroxy-5a,10b-diphenylcoumarano-2′,3′,2,3-coumarane (DCBP); 1,1-bis(3,5-dimethyl-4-hydroxyphenyl)cyclododecane; 4,4′dihydroxy-1,1-biphenyl; 1,4-bis(2-(4-hydroxy-3-methylphenyl)-2-propyl)benzene; 2,4′-dihydroxyphenyl sulfone; 4,4′-dihydroxydiphenylsulfone (BPS); 4,4′-difluorodiphenylsulfone (DFDPS); bis(4-hydroxyphenyl)methane; 2,6-dihydroxy naphthalene; hydroquinone; resorcinol; 1,2-benzenedithiol; 1,3-benzenedithiol; 1,4-benzenedithiol; 4-methyl-1,2-benzenedithiol; 3,4-dimercapto-phenol; 3,6-dichloro-1,2-benzenedithiol; 4-chloro-1,3-benzenedithiol; 9,10-anthracenedithiol; 1,3,5-benzenetrithiol; 1,1 ′-biphenyl-4,4′-dithiol; 4,4′-oxybis[benzenethiol]; 4,4′-thiobis[benzenethiol]; 4,4′-methylenebis[benzenethiol], 4,4′-(1-methylethylidene)bis[benzenethiol]; 1,4-phenylenebis [(4-mercaptophenyl)methanone; 4,4′-sulfonylbis[benzenethiol]; bis(4-mercaptophenyl)methanone; 3,7-Dibenzofurandithiol; 4,4′-sulfonylbis[2-chloro-benezenethiol; 4,4′-[2,2,2-trifluoro-1-(trifluoromethyl)ethylidene]bis [benzenethiol]; and combinations thereof.

The aromatic polyethers may be prepared using methods known to one skilled in the art. For example, the aromatic polyethers may be prepared by reacting the halosulfone sulfonate having structure (I) and/or structure (II) with an aromatic compound. The aromatic polyethers of the present invention may be prepared by a variety of methods including those provided in the example section of this disclosure. For example, in one embodiment, the reaction may be carried out in the presence of an alkali metal carbonate and a solvent. In another embodiment, the reaction may be carried out in the presence of a phase transfer catalyst and a solvent.

In yet another embodiment, the present invention provides an aromatic polyether comprising structural units derived from a halosulfone sulfonate having structure (I) and an aromatic compound having structure (V).

Aromatic polyethers described herein may be transformed into useful articles directly, or may be blended with one or more additional polymers or polymer additives and subjected to injection molding, compression molding, extrusion methods, solution casting methods, and like techniques to provide useful articles. More particularly aromatic polyethers described herein may be employed to prepare polymer electrolyte membranes useful in the preparation of fuel cells.

The following examples are intended only to illustrate methods and embodiments in accordance with the invention, and as such should not be construed as imposing limitations upon the claims.

### EXAMPLES

General Procedures: Toluene used in the polymerization step was purified through a Solv-Tek solvent purification system, containing columns packed with activated R3-15 deoxygenation catalyst and 8 to 14 mesh activated alumina. (Solv-Tek, Inc. 216 Lewisville Road, Berryville, Va. 22611). 2,6-dichlorobenzenethiol was purchased from Acros Organics. 1,2-dibromotetrafluoroethane and 2,4-difluorobenzenethiol were bought from SynQuest Laboratories, Alachua, Fla., 32616-0309, U.S.A. All other chemicals were purchased from Aldrich and used as received, unless otherwise specified. Reactions carried out with air- and/or water-sensitive compounds were conducted under dry nitrogen (purified through Trigon Technologies Big Moisture Traps) using standard Schlenk line techniques. NMR spectra were recorded on a Bruker Avance 400 (¹H, 400 MHz) spectrometer and chemical shifts are referenced to residual solvent shifts. Molecular weights are reported as number average (Mn) or weight average (Mw) molecular weight and were determined by gel permeation chromatography (GPC) analysis on a Perkin Elmer Series 200 instrument equipped with RI detector. Polyethyleneoxide molecular weight standards were used to construct a broad standard calibration curve against which the molecular weights of polymers were determined. The temperature of the gel permeation column (Polymer Laboratories PLgel 5 micrometer MIXED-C, 300×7.5 mm) was 40° C. and the mobile phase employed was a 0.05 M LiBr solution in DMAc.

Scheme 2 shows the route by which lithium 2-(2,6-dichlorophenyl)sulfonyltetrafluoroethanesulfonate, compound (6), was synthesized.

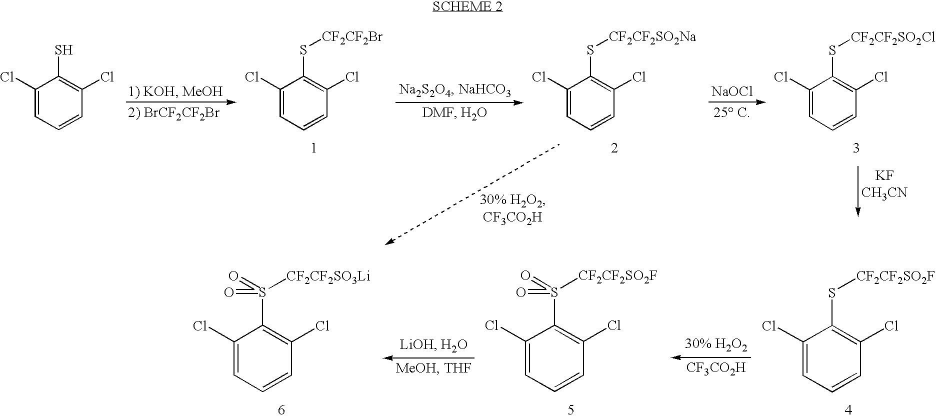

PREPARATORY STEP provides a method for the preparation of 2,6-(2-bromotetrafluoroethyl)dichlorothiobenzene, compound (1).

2,6-Dichlorothiobenzene (50.0 grams (g), 279 millimoles (mmol)) was dissolved in methanol (100 milliliters (ml)). Potassium hydroxide (KOH, 18.0 g, 321 mmol, 87 percent assay) was dissolved in methanol (MeOH, 200 ml) and slowly added to the above solution. The solution was heated to reflux for 10 minutes, and concentrated under reduced pressure to provide a yellow solid, which was dried under vacuum at 120° C. for 16 hours. The solid was then partially dissolved in anhydrous dimethyl sulfoxide (DMSO, 200 ml) to form a mixture. 1,2-Dibromotetrafluoroethane (77.7 g, 299 mmol) was slowly added to the mixture over a period of 30 minutes at room temperature (25° C.). The reaction mixture was then heated to 65° C. and stirred at 65° C. for 3 hours. The reaction mixture was then cooled to 25° C. and water (400 ml) and methylene dichloride (CH₂Cl₂, 100 ml) were added. The phases were separated and the aqueous phase was further extracted with CH₂Cl₂ (3×100 ml). The combined organic phases were washed with 1 percent sodium hydroxide (NaOH(aq), 1×500 ml) and brine (1×500 ml), dried over magnesium sulfate (MgSO₄), filtered, and concentrated under reduced pressure to provide a brown liquid which was purified by vacuum distillation (60° C. at 30 milliTorr) to provide 94.8 g of 2,6-(2-bromotetrafluoroethyl)dichlorothiobenzene, compound (1).

¹H NMR (CDCl₃, 400 MHz): δ 7.51 (2H, d, J=8.0 Hz, ArH) and 7.39 (1H, t, J=8.0 Hz, ArH).

### Example 1

### Provides a Process for the Preparation of Sodium 2-(2,6-dichlorothiobenzene)tetrafluoroethanesulfinate, compound (2)

2,6-(2-Bromotetrafluoroethyl)dichlorothiobenzene compound (1) (150.0 g, 419 mmol) was dissolved in N,N-dimethyl formamide (DMF, 125 ml) and added to a 1 liter (L) round-bottomed flask containing sodium dithionite (160 g, 921 mmol), sodium bicarbonate (NaHCO₃, 77.0 g, 917 mmol), and deionized water (225 ml). The reaction mixture became exothermic and the temperature of the reaction mixture increased to 40° C. Sulfur dioxide gas was released from the reaction mixture. The reaction mixture was then heated to 65° C. and stirred at 65° C. for 1 hour. The reaction mixture was then heated to 75° C. and stirred at 75° C. for 2 hours. The reaction mixture was then cooled to 25° C. and ethyl acetate (500 ml) was added to the mixture and stirred. The mixture was then filtered over Celite and a C-frit. The phases were separated and the aqueous phase was further extracted with ethyl acetate (2×250 ml). The combined organic phases were washed with brine (2×400 ml), dried over MgSO₄, filtered, and concentrated under reduced pressure to provide a white powder. A 1:1 mixture of CHCl₃:hexanes (500 ml) was added to the white powder, the resultant mixture filtered to provide 125.1 g of sodium 2-(2,6-dichlorothiobenzene)tetrafluoroethanesulfinate, compound (2). ¹H NMR (DMSO-d6, 400 MHz): δ 7.68 (2H, d, J=8.0 Hz, ArH), and 7.56 (1H, t, J=8.0 Hz, ArH).

### Example 2

### Provides a Process for the Preparation of 2-(2,6-dichlorothiobenzene)tetrafluoroethanesulfonyl chloride, compound (3)

Sodium 2-(2,6-dichlorothiobenzene)tetrafluoroethanesulfinate, compound (2) (37.2 g, 102 mmol) was dissolved in deionized water (250 ml). Bleach (400 ml, 6.15 percent sodium hypochlorite solution in water) was added at 25° C., resulting in a cloudy suspension. The mixture was vigorously stirred for 2 minutes and methylene dichloride (200 ml) was added. The phases were separated and the aqueous phase was further extracted with CH₂Cl₂ (3×100 ml). The combined organic phases were washed with brine (2×150 ml), dried over MgSO₄, filtered, and concentrated under reduced pressure to provide a colorless liquid which was purified by vacuum distillation (112° C. at 75 millitorr (mTorr)) to provide 31.5 g of 2-(2,6-dichlorothiobenzene)tetrafluoroethanesulfonyl chloride, compound (3). ¹H NMR (CDCl₃, 400 MHz): δ 7.53 (2H, d, J=8.0 Hz, ArH); and 7.42 (1H, t, J=8.0 Hz, ArH). ¹⁹F NMR (CDCl₃, 564.4 MHz): −83.5 (2F, m) and -103.2 (2F, bm).

### Example 3

### Provides a Process for the Preparation of 2-(2,6-dichlorothiobenzene)tetrafluoroethanesulfonyl fluoride, compound (4)

2-(2,6-dichlorothiobenzene)tetrafluoroethanesulfonyl chloride, compound (3) (31.0 g, 82.1 mmol) was dissolved in anhydrous acetonitrile (CH₃CN, 50 ml) and added to an oven-dried round-bottom flask containing anhydrous potassium fluoride (KF, 25.5 g, 439 mmol). The reaction mixture was heated to 70° C. over a period of 10 minutes and stirred at 70° C. for 16 hours. The resultant mixture was filtered and concentrated under reduced pressure to provide a colorless liquid which was purified by vacuum distillation (60° C. to 61° C. at 20 mTorr), to provide 29.6 g of 2-(2,6-dichlorothiobenzene)tetrafluoroethanesulfonyl fluoride, compound (4). ¹H NMR (CDCl₃, 400 MHz): δ 7.53 (2H, d, J=8.0 Hz, ArH) and 7.42 (1H, t, J=8.0 Hz, ArH). ¹⁹F NMR (CDCl₃, 564.4 MHz): 46.6 (1F, m, SO₂F), −84.9 (2F, m, CF₂) and −106.6 (2F, quartet, JFF=5 Hz, CF₂).

### Example 4

### Provides a Process for the Preparation of 2-(2,6-dichlorobenzenesulfonyl)tetrafluoroethanesulfonyl fluoride, compound (5)

2-(2,6-dichlorothiobenzene)tetrafluoroethanesulfonyl fluoride, compound (4) (22.6 g, 62.6 mmol), 30 percent hydrogen peroxide (H₂O₂ (aq), 25 ml), and trifluoroacetic acid (65 ml) were added to a round-bottom flask. The resultant biphasic mixture was stirred under reflux for 16 hours. The resultant colorless monophasic solution was poured on ice water and extracted with ethylacetate (4×100 ml). The combined organic phases were treated with saturated NaHCO₃(aq) to neutralize the excess trifluoroacetic acid.(Caution: do not used closed system because CO₂ gas is released), washed with brine (1×100 ml), dried over MgSO₄, filtered, and concentrated under reduced pressure to provide a white crystalline solid which was twice recrystallized from hexane to provide 17.1 g 2-(2,6-dichlorobenzenesulfonyl)tetrafluoroethanesulfonyl fluoride, compound (5). ¹H NMR (CDCl₃, 400 MHz): δ 7.52 (3H, b, ArH). ¹⁹F NMR (CDCl₃, 564.4 MHz): 47.2 (1F, quintet, JFF=7 Hz, SO₂F), −105.0 (1F, ddd, JFF=230 Hz, JFF=7 Hz, JFF=2 Hz, CFF), −107.6 (2F, m, CF₂), and −111.5 (1F, ddd, JFF=230 Hz, JFF=8 Hz, JFF=3 Hz, CFF).

### Example 5

### Provides a Process for the Preparation of Lithium 2-(2,6-dichlorophenylsulfonyl)tetrafluoroethanesulfonate, compound (6)

In a 250 ml round-bottom flask were added lithium hydroxide hydrate (LiOH hydrate, 2.39 g, 56.9 mmol), water (40 ml), and methanol (MeOH, 20 ml) and the resultant solution cooled to 0° C. 2-(2,6-dichlorobenzenesulfonyl)tetrafluoroethanesulfonyl fluoride, compound (5) (10.0 g, 25.4 mmol) was dissolved in THF (20 ml) and MeOH (20 ml) and slowly added to the cooled solution in the round-bottom flask. The resultant mixture was then refluxed for 2 hours, cooled to 25° C., extracted with ethyl acetate (3×100 ml) and brine (100 ml). The combined organic phases were dried over MgSO₄, filtered, and concentrated under reduced pressure to provide a white solid which was filtered, washed with a 1:1 mixture of chloroform (CHCl₃):hexanes (3×200 ml), and dried under vacuum overnight at 80° C. to provide 9.51 g of 2-(2,6-dichlorophenylsulfonyl)tetrafluoroethanesulfonate, compound (6). ¹H NMR (DMSO-d6, 400 MHz): δ 7.67 (3H, b, ArH). ¹⁹F NMR (DMSO-d6, 564.4 MHz): −98.8 (1F, dd, JFF=220 Hz, JFF=6 Hz, CFF), −106.3 (1F, dd, JFF=220 Hz, JFF=6 Hz, CFF), and −109.2 (2F, qd, JFF=220 Hz, JFF=7 Hz, CF2). MS (ESI−) 389.04281 grams per mole.

Scheme 3 shows the route by which lithium 2-(2,4-difluorophenylsulfonyl)tetrafluoroethanesulfonate, compound (12), was synthesized.

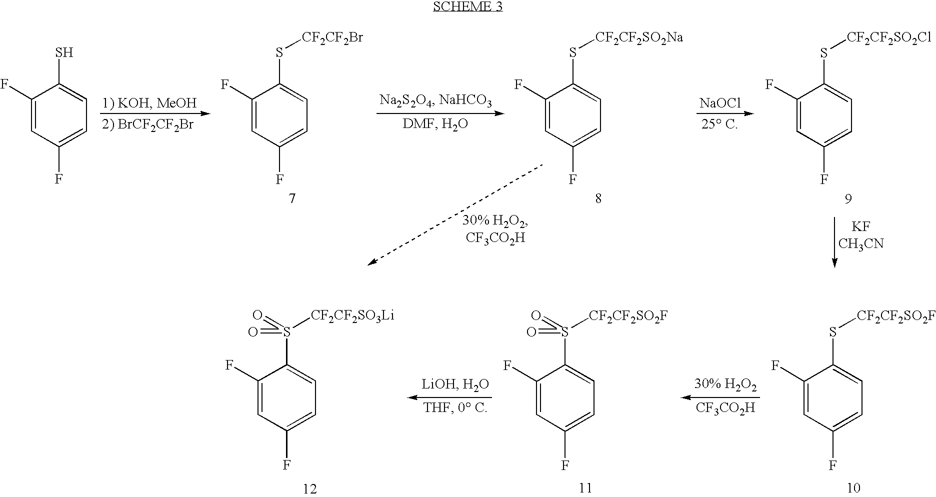

PREPARATORY STEP provides a method for the preparation of 2,4-(2-bromotetrafluoroethyl)difluorothiobenzene, compound (7).

2,4-difluorothiobenzene (59.4 g, 407 mmol) was dissolved in methanol (150 ml). Potassium hydroxide (KOH, 26.3 g, 469 mmol, 87 percent assay) was dissolved in MeOH (150 ml) and slowly added to the above solution. The solution was stirred for 10 minutes, and concentrated under reduced pressure to provide a white solid, which was dried under vacuum at 125° C. for 24 hours. The solid was then dissolved in anhydrous dimethyl sulfoxide (DMSO, 200 ml) and the resultant solution was slowly transferred over a period of 50 minutes to a 1 L round-bottom flask containing 1,2-dibromotetrafluoroethane (115 g, 443 mmol) and DMSO (50 ml). The reaction mixture turned exothermic and the temperature of the reaction mixture increased to 40° C. White colored solids precipitated out from the reaction mixture. Following complete addition of the solution, the reaction mixture was heated to 70° C. and stirred at 70° C. for 2 hours. The reaction mixture was cooled to 25° C., water (300 ml) and methylene dichloride (CH₂Cl₂, 100 ml) were added. The phases were separated and the aqueous phase was further extracted with CH₂Cl₂ (3×100 ml). The combined organic phases were washed with 1 percent sodium hydroxide (NaOH(aq), 1×500 ml) and brine (1×500 ml), dried over MgSO₄, filtered, and concentrated under vacuum to provide a brown liquid which was purified by vacuum distillation (36° C. at 45 mTorr) to provide 106.5 g of 2,4-(2-bromotetrafluoroethyl)difluorothiobenzene, compound (7). ¹H NMR (CDCl₃, 400 MHz): δ 7.67 (1H, quartet, J=7.6 Hz, ArH), and 6.99 (2H, bt, J=8.0 Hz, ArH). ¹⁹F NMR (CDCl₃, 564.4 MHz): −68.5 (2F, t, JFF=7 Hz, CF₂), −91.0 (2F, m, CF₂), −104.0 (1F, bm, ArF), and −108.1 (1F, m, ArF).

### Example 6

### Provides a Process for the Preparation of Sodium 2-(2,4-difluorothiobenzene)tetrafluoroethanesulfinate, compound (8)

2,4-(2-bromotetrafluoroethyl)difluorothiobenzene, compound (7) (21.2 g, 65.2 mmol) was dissolved in DMF (25 ml) and added to a 250 ml round-bottom flask containing sodium dithionite (25.7 g, 148 mmol), NaHCO₃ (12.1 g, 144 mmol), and deionized water (40 ml). The mixture was first heated to 65° C. and was stirred at 65° C. for 1 hour, then heated to 75° C. and was stirred at 75° C. for 2 hours. The mixture was then cooled to 25° C., ethyl acetate (150 ml) was added and the resultant mixture filtered over Celite and a C-frit. The phases in the filtrate was separated and the aqueous phase was extracted with ethyl acetate (2×200 ml). The combined organic phases were washed with brine (2×100 ml), dried over MgSO₄, filtered, and concentrated under vacuum to provide a white powder, which was purified using a 1:1 mixture of CHCl₃:hexanes (500 ml) to provide 11.6 g of sodium 2-(2,4-difluorothiobenzene)tetrafluoroethanesulfinate, compound (8). ¹H NMR (DMSO-d6, 400 MHz): δ 7.74 (1H, quartet, J=8.0 Hz, ArH), 7.49 (1H, td, J=8.0 Hz, J=2.4 Hz, ArH), and 7.23 (1H, td, J=8.0 Hz, J=2.4 Hz, ArH). ¹⁹F NMR (DMSO-d6, 564.4 MHz): δ−85.7 (2F, bm, CF₂), −101.0 (1F, bm, ArF), −105.4 (1F, bm, ArF), and −127.7 (2F, bm, CF₂).

### Example 7

### Provides a Process for the Preparation of 2-(2,4-difluorothiobenzene)tetrafluoroethanesulfonyl chloride, compound (9)

Sodium 2-(2,4-difluorothiobenzene)tetrafluoroethanesulfinate, compound (8) (11.6 g, 34.9 mmol) was dissolved in deionized water (100 ml). Bleach (50 ml, 6.15 percent sodium hypochlorite solution in water) was added at 25 ° C., resulting in a cloudy suspension. The mixture was vigorously stirred for 2 minutes, methylene dichloride (100 ml) was added, and the phases separated and the aqueous phase extracted with methylene chloride (2×100 ml). The combined organic phases were washed with brine (1×100 ml), dried over MgSO₄, filtered, and concentrated under vacuum to provide a colorless liquid which was purified by vacuum distillation to provide 10.1 g of Sodium 2-(2,4-difluorothiobenzene)tetrafluoroethanesulfinate, compound (9). ¹H NMR (CDCl₃, 400 MHz): δ 7.71 (1H, quartet, J=8.0 Hz, ArH), and 7.02 (2H, t, J=8.0 Hz, ArH). ¹⁹F NMR (CDCl₃, 564.4 MHz): −90.5 (2F, quartet, JFF=5 Hz, CF₂), −103.6 (1F, bm, ArF), −106.8 (1F, m, ArF), −108.1 (2F, m, CF₂).

### Example 8

### Provides a Process for the Preparation of 2-(2,4-difluorothiobenzene)tetrafluoroethanesulfonyl fluoride, compound (10)

2-(2,4-difluorothiobenzene)tetrafluoroethanesulfonyl chloride, compound (9) (10.0 g, 29.0 mmol) was dissolved in anhydrous CH₃CN (50 ml) and added to an oven-dried round-bottom flask containing anhydrous potassium fluoride (8.6 g, 148 mmol). The reaction mixture was heated to 70° C. over a period of 10 minutes, stirred at 70° C. for 16 hours, filtered, and the filtrate concentrated under vacuum to provide a colorless liquid, which was purified by vacuum distillation (52° C. at 35 mTorr), to provide 9.1 g of 2-(2,4-difluorothiobenzene)tetrafluoroethanesulfonyl fluoride, compound (10). ¹H NMR (CDCl₃, 400 MHz): δ 7.70 (1H, quartet, J=7.6 Hz, ArH), and 7.02 (2H, t, J=8.0 Hz, ArH). ¹⁹F NMR (CDCl₃, 564.4 MHz): 41.2 (1F, m, SO₂F), −92.0 (2F, sextet, JFF=4 Hz, CF₂), −103.5 (1F, bm, ArF), −106.7 (1F, m, ArF), −111.4 (2F, m, CF₂).

### Example 9

### Provides a Process for the Preparation of 2-(2,4-difluorobenzenesulfonyl)tetrafluoroethanesulfonyl fluoride, compound (11)

2-(2,4-difluorothiobenzene)tetrafluoroethanesulfonyl fluoride (10) (9.08 g, 27.7 mmol), 30 percent hydrogen peroxide (H₂O₂(aq), 15 ml) and trifluoroacetic acid (25 ml) were added to a round-bottom flask. The resultant mixture was stirred under reflux for 48 hours resulting in the formation of a colorless monophasic solution, which was poured on ice water. The resultant solution was extracted with ethyl acetate (2×100 ml) and methylene dichloride (2×100 ml). The combined organic phases was neutralized with saturated NaHCO₃(aq) (2×200 ml) to remove excess trifluoroacetic acid, washed with brine (1×100 ml), dried over MgSO₄, filtered, and concentrated under vacuum (64° C. at 25 mTorr) to provide a colorless oil which crystallized upon standing to provide 9.1 g of 2-(2,4-difluorobenzenesulfonyl)tetrafluoroethanesulfonyl fluoride, compound (11), as a white solid. ¹H NMR (CDCl₃, 400 MHz): δ 8.08 (1H, m, ArH), 7.23 (1H, m, ArH), and 7.15 (1H, m, ArH). ¹⁹F NMR (CDCl₃, 564.4 MHz): 41.5 (1F, m, SO₂F), −96.2 (1F, m, ArF), −96.2 (1F, m, ArF), −111.8 (2F, d, JFF=6 Hz, CF₂), and −116.2 (2F, m, CF₂).

### Example 10

### Provides a Process for the Preparation of Lithium 2-(2,4-difluorophenylsulfonyl)tetrafluoroethanesulfonate, compound (12)

In a 250 ml round-bottom flask were added 2-(2,4-difluorobenzenesulfonyl)tetrafluoroethanesulfonyl fluoride, compound (11) (8.11 g, 22.5 mmol) and tetrahydrofuran (THF, 15 ml). The resultant solution was cooled to 0° C. and LiOH hydrate (1.91 g, 45.4 mmol) dissolved in water (10 ml) was added. After complete addition of LiOH hydrate the reaction mixture turned exothermic and the temperature of the reaction mixture increased to 35° C. The reaction mixture was cooled to 5 ° C. over a period of 30 minutes. When a litmus paper test showed a pH of about 8, the mixture was concentrated in vacuum, ethyl acetate (100 ml) and brine (100 ml) were added and the phases separated. The aqueous phase was extracted with ethyl acetate (2×100 ml). The combined organic phases were dried over MgSO₄, filtered, and concentrated under vacuum to provide a white solid which was dried under vacuum at 80° C. for a period of about 2 hours to provide 7.81 g of lithium 2-(2,4-difluorophenylsulfonyl)tetrafluoroethanesulfonate, compound (12). ¹H NMR (DMSO-d6, 400 MHz): δ 8.10 (1H, m, ArH), 7.80 (1H, m, ArH), and 7.50 (1H, td, J=8.8 Hz, J=2.4 Hz, ArH). ¹⁹F NMR (DMSO-d6, 564.4 MHz): −89.7 (1F, m, ArF), −96.3 (1F, m, ArF), −105.9 (2F, bm, CF₂), −108.8 (2F, bd, CF₂). MS (neg MALDI-TOF, neat) 356.8859 grams per mole.

### Example 11

### Provides a Process for the Preparation of Co-Polymer of Lithium 2-(2,4-difluorophenylsulfonyl)tetrafluoroethanesulfonate, compound (12) with biphenol

2-(2,4-difluorophenylsulfonyl)tetrafluoroethanesulfonate, compound (12) (1.969 g, 5.408 mmol), biphenol (1.025, 5.503 mmol) and K₂CO₃ (1.41 g, 10.2 mmol) were added to a round-bottom flask equipped with a mechanical stirrer, an addition funnel, and a simple distillation apparatus. DMSO (7.5 ml) and toluene (3.0 ml) were added to the flask using a syringe. The mixture was heated to 145° C. and stirred at 145° C. for 24 hours with azeotropic water removal, under a nitrogen atmosphere. The polymerization reaction mixture was sampled and assayed by GPC. The weight average (Mw) and number average (Mn) molecular weights were found to be 9,360 grams per mole and 4,650 grams per mole, respectively. A 1:1 ratio of polymer:cyclic tetramer was observed by GPC. The polymer was precipitated into vigorously stirred isopropanol (400 ml), filtered, washed with methanol and water, and dried.

### Example 12

### Provides a Process for the Preparation of Co-Polymer of Lithium 2-(2,4-difluorophenylsulfonyl)tetrafluoroethanesulfonate, compound (12), biphenol, and 4,4′-difluorodiphenylsulfone

2-(2,4-difluorophenylsulfonyl)tetrafluoroethanesulfonate, compound (12) (1.025 g, 2.814 mmol), 4,4′-difluorodiphenylsulfone (DFDPS) (0.699 g, 2.75 mmol), biphenol (1.025, 5.503 mmol) and K₂CO₃ (1.91 g, 13.8 mmol) were added to a round-bottom flask equipped with a mechanical stirrer, an addition funnel, and a distillation apparatus. DMSO (5.0 ml) and toluene (2.5 ml) were added to the flask using a syringe. The mixture was heated to 130° C. and stirred at 130° C. for 21 hours with azeotropic water removal, under a nitrogen atmosphere. The polymerization reaction mixture was sampled and assayed by GPC. The weight average (Mw) and number average (Mn) molecular weights were found to be 35,500 grams per mole and 15,700 grams per mole, respectively. A 9:1 ratio of polymer:cyclic tetramer was observed by GPC. The polymer was precipitated into vigorously stirred isopropanol (400 ml), filtered, washed with methanol and water, and dried.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. An aromatic polyether comprising structural units derived from a halosulfone sulfonate having structure (I): 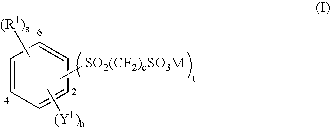
wherein R¹ is a C₃-C₂₅ aromatic radical, a C₃-C₂₅ cycloaliphatic radical, or a C₁-C₁₀ aliphatic radical; M is hydrogen or a charge balancing cation; Y¹ is independently at each occurrence a halogen; “t” is an integer having a value of 1 or 2; “s” is an integer having a value 0 to 3, “b” is an integer having a value 1 to 3; and “c” is an integer having a value 1 to 20.

2. The aromatic polyether according to claim 1, wherein Y¹ comprises fluorine, chlorine or a combination thereof, “s” is an integer having a value O, and “b” is an integer having a value 2.

3. The aromatic polyether according to claim 2, wherein Y¹ is attached to ring positions 2 and 4 of structure (I).

4. The aromatic polyether according to claim 2, wherein Y¹ is attached to ring positions 2 and 6 of structure (I).

5. The aromatic polyether according to claim 2, wherein Y¹ is fluorine.

6. The aromatic polyether according to claim 2, wherein Y¹ is chlorine.

7. The aromatic polyether according to claim 2, wherein one Y¹ substituent is chlorine and the other is fluorine.

8. The aromatic polyether according to claim 1, wherein “c” is an integer having a value 2.

9. The aromatic polyether according to claim 1, wherein “c” is an integer having a value 3.

10. The aromatic polyether according to claim 1, wherein M comprises sodium, potassium, lithium, calcium, magnesium, or barium.

11. The aromatic polyether according to claim 1, wherein R¹ is a C₃-C₂₅ aromatic radical which is free of aliphatic CH bonds.

12. The aromatic polyether according to claim 1, wherein R¹ is a perfluoroaliphatic radical.

13. An aromatic polyether comprising structural units derived from halosulfone sulfonate having structure (II): 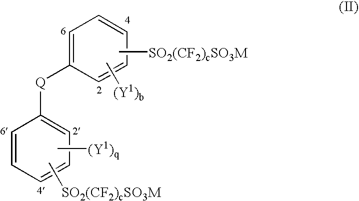
wherein Q is O, S, or SO₂; M is hydrogen or a charge balancing cation; Y¹ is independently at each occurrence a halogen; “b” is an integer having a value 1 to 4; “q” is an integer having a value 0 to 4; and “c” is an integer having a value 1 to 20.

14. The aromatic polyether according to claim 13, wherein Y¹ comprises fluorine, chlorine, or a combination thereof, “s” is an integer having a value 0, and “b” is an integer having a value 0 or 2.

15. The aromatic polyether according to claim 14, wherein when “b” is an integer having a value 2, Y¹ is attached to ring positions 2 and 2′, of structure (II).

16. The aromatic polyether according to claim 14, wherein when “b” is an integer having a value 2, Y¹ is attached to ring positions 2,2′, 6, and 6′ of structure (II).

17. The aromatic polyether according to claim 14, wherein Y¹ is fluorine.

18. The aromatic polyether according to claim 14, wherein Y¹ is chlorine.

19. The aromatic polyether according to claim 14, wherein one Y¹ substituent is chlorine and the other is fluorine.

20. The aromatic polyether according to claim 13, wherein “c” is an integer having a value 2.

21. The aromatic polyether according to claim 13, wherein “c” is an integer having a value 3.

22. The aromatic polyether according to claim 13, wherein M comprises sodium, potassium, lithium, calcium, magnesium, or barium.

23. The aromatic polyether according to claim 1, further comprising structural units derived from an aromatic compound having structure (V): 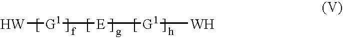
wherein each G¹ is independently at each occurrence a C₃-C₂₅ aromatic radical; E is independently at each occurrence a bond, a C₃-C₂₅ cycloaliphatic radical, a C₃-C₂₅ aromatic radical, a C₁-C₂₀ aliphatic radical, a sulfur-containing linkage, a selenium-containing linkage, a phosphorus-containing linkage, or an oxygen atom; “f” is a number greater than or equal to 1; “g” is either 0 or 1; “h” is a whole number including 0; and W is independently at each occurrence O, S, or Se.

24. The aromatic polyether according to claim 23, wherein the aromatic compound is selected from the group consisting of 1,1-bis(4-hydroxyphenyl)cyclopentane; 2,2-bis(3-allyl-4-hydroxyphenyl)propane; 2,2-bis(2-t-butyl-4-hydroxy-5-methylphenyl)propane; 2,2-bis(3-t-butyl-4-hydroxy-6-methylphenyl)propane; 2,2-bis(3-t-butyl-4-hydroxy-6-methylphenyl)butane; 4,4′-biphenol; 2,2′,6,8-tetramethyl-3,3′,5,5′-tetrabromo-4,4′-biphenol; 2,2′,6,6′-tetramethyl-3,3′,5-tribromo-4,4′-biphenol; 1,1-bis(4-hydroxyphenyl)-2,2,2-trichloroethane; 1,1-bis(4-hydroxyphenyl)ethane; 1,1-bis(4-hydroxy-2-chlorophenyl)ethane; 2,2-bis(4-hydroxyphenyl)propane (bisphenol-A); 1,1-bis(4-hydroxyphenyl)propane; 2,2-bis(3-chloro-4-hydroxyphenyl)propane; 1,1-bis(3-phenyl-4-hydroxyphenyl)cyclohexane; 1,1-bis(3,5-dichloro-4-hydroxyphenyl)cyclohexane; 1,1-bis(3,5-dibromo-4-hydroxyphenyl)cyclohexane; 1,1-bis(3,5-dimethyl-4-hydroxyphenyl)cyclohexane; 4,4′-[1-methyl-4-(1-methyl-ethyl)-1,3-cyclohexandiyl]bisphenol (1,3 BHPM); 4-[1-[3-(4-hydroxyphenyl)-4-methylcyclohexyl]-1-methyl-ethyl]-phenol (2,8 BHPM); 3,8-dihydroxy-5a,10b-diphenylcoumarano-2′,3′,2,3-coumarane (DCBP); 1,1-bis(3,5-dimethyl-4-hydroxyphenyl)cyclododecane; 4,4′dihydroxy-1,1-biphenyl; 1,4-bis(2-(4-hydroxy-3-methylphenyl)-2-propyl)benzene; 2,4′-dihydroxyphenyl sulfone; 4,4′-dihydroxydiphenylsulfone (BPS); 4,4′-difluorodiphenylsulfone (DFDPS); bis(4-hydroxyphenyl)methane; 2,6-dihydroxy naphthalene; hydroquinone; resorcinol; 1,2-benzenedithiol; 1,3-benzenedithiol; 1,4-benzenedithiol; 4-methyl-1,2-benzenedithiol; 3,4-dimercapto-phenol; 3,6-dichloro-1,2-benzenedithiol; 4-chloro-1,3-benzenedithiol; 9,10-anthracenedithiol; 1,3,5-benzenetrithiol; 1,1′-biphenyl-4,4′-dithiol; 4,4′-oxybis[benzenethiol]; 4,4′-thiobis [benzenethiol]; 4,4′-methylenebis [benzenethiol], 4,4′-(1-methylethylidene)bis[benzenethiol]; 1,4-phenylenebis [(4-mercaptophenyl)methanone; 4,4′-sulfonylbis[benzenethiol]; bis(4-mercaptophenyl)methanone; 3,7-Dibenzofurandithiol; 4,4′-sulfonylbis[2-chloro-benzenethiol; 4,4′-[2,2,2-trifluoro-1-(trifluoromethyl)ethylidene]bis[benzenethiol]; and combinations thereof.

25. An aromatic polyether comprising structural units derived from a halosulfone sulfonate having structure (I) and an aromatic compound having structure (V): 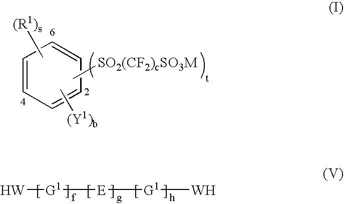
wherein R¹ is a C₃-C₂₅ aromatic radical, a C₃-C₂₅ cycloaliphatic radical, or a C₁-C₁₀ aliphatic radical; M is hydrogen or a charge balancing cation; Y¹ is independently at each occurrence a halogen; “t” is an integer having a value of 1 or 2; “s” is an integer having a value 0 to 3, “b” is an integer having a value 1 to 4; and “c” is an integer having a value 1 to 20; and
wherein each G¹ is independently at each occurrence a C₃-C₂₅ aromatic radical; E is independently at each occurrence a bond, a C₃-C₂₅ cycloaliphatic radical, a C₃-C₂₅ aromatic radical, a C₁-C₂₀ aliphatic radical, a sulfur-containing linkage, a selenium-containing linkage, a phosphorus-containing linkage, or an oxygen atom; “f” is a number greater than or equal to 1; “g” is either 0 or 1; “h” is a whole number including 0; and W is independently at each occurrence O, S, or Se.
